(19) United States
(12) Patent Application Publication
(10) Pub. No.: US 2011/0191277 A1
(43) Pub. Date: Aug. 4, 2011

(54) AUTOMATIC DATA MINING PROCESS CONTROL

(76) Inventors: José Luis Agúndez Dominguez, Madrid (ES); Jesus Renero Quintero, Madrid (ES)

(21) Appl. No.: 12/999,396

(22) PCT Filed: Aug. 29, 2008
(86) PCT No.: PCT/IB08/02245

§ 371 Date: Apr. 15, 2011

Related U.S. Application Data
(60) Provisional application No. 61/061,757, filed on Jun. 16, 2008.

(51) Int. Cl. G06F 15/18

(52) U.S. Cl. 706/12

(57) ABSTRACT

A data mining system includes a planning and learning module which receives as input a knowledge model and a set of goals and automatically produces as output a plurality of plans. The system includes a data mining processing unit which receives the plans as instructions and automatically creates results which are provided back to the planning and learning module as feedback. A method for data mining includes the steps of receiving as input at a planning and learning module a knowledge model and a set of goals. There is the step of automatically producing as output of the planning and learning module a plurality of plans from the input. There is the step of receiving by a data mining processing unit the plans as instructions. There is the step of automatically creating results by the data mining processing unit. There is the step of providing back to the planning and learning module the results as feedback.

### TECHNICAL FIELD

The present invention is related to automated data mining that uses a knowledge model and goals as input. (As used herein, references to the “present invention” or “invention” relate to exemplary embodiments and not necessarily to every embodiment encompassed by the appended claims.) More specifically, the present invention is related to automated data mining that uses a knowledge model and goals as input to a planning and learning module which provides plans as instructions to a data mining processing unit which in turn provides feedback to the planning and learning module to correct or reinforce the model used.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

The field of Data Mining has been widely explored and its applications cover very different areas, from banking, to genetics, and also telecommunications. Several examples of the existing approaches to Data Mining are offered below.

Although in the early days of Data Mining the solutions were predominantly adhoc for each different application and purpose, as the technology has matured there have appeared industry standards, such as the CRISP-DM process. (CRISP-DM process—http://www.crisp-dm.org/).

The Cross Industry Standard Process for Data Mining, or CRISP-DM, incorporated by reference herein, was a project to develop an industry- and tool-neutral data mining process model [reference to CRISP-DM]. The CRISP-DM concept was conceived by DaimlerChrysler (then Daimler-Benz), SPSS (then ISL), and NCR, in 1996 and evolved over several years, building on industry experience, both company-internal and through consulting engagements, and specific user requirements.

Although most data mining projects traditionally had been one-off design and implementation efforts by highly specialized individuals, they suffered from budget and deadline overruns. CRISP-DM had as goals to bring data mining projects to fruition faster and more cheaply. Since data mining projects that followed ad hoc processes tended to be less reliable and manageable, by standardizing the data mining phases and integrating and validating best practices from experts in diverse industry sectors, data mining projects could become both reliable and manageable.

It should be noted that data mining project success depends heavily on the data available and the quality of that data. As a whole, placing greater emphasis on current and future data analysis requirements during system and application design can greatly reduce future data mining effort. Poor data design and organization poses one of the greatest challenges to data mining projects.

Some efforts are found in the prior art regarding so-called automation of data processing tasks, usually trying to optimize some data transformation step that is part of a bigger process.

One of them is found in patent US 20060112110, incorporated by reference herein, with the title “Automated data enhancement processing system for database management system performs set of text analytics processes on structured data to generate normalized data automatically”, which addresses the automated normalization of data stored in a database system.

This “automated data enhancement processing system” does not cover the overall data mining process which is the focus of the present invention, only aims to automate the internal mechanisms of data normalization, limited to text analysis techniques. Data normalization of text structured data is just one of out of the many possible transformations that can be performed during the Data Preparation phase, in the previously described CRISP-DM process.

Another related patent, US 20040010505, incorporated by reference herein, titled “Automatic data mining method in domain specific analytic application, involves scheduling steps of populating input data schema, training of predefined data mining model and scoring of input data from input data schema”, addresses the automation of the scheduling of the different tasks involved in a simplified version of the process of data mining. This patent belongs to a family that describes IBM's “Intelligent Miner” data mining product.

IBM's method basically leverages on the combination of pre-configured data schemas and models that are specific for a given domain, with a task scheduler to control the execution of three main tasks: populating input data schema (corresponding to simplified Data preparation in CRISP-DM), production training a predefined model (corresponding to simplified Modeling), and production scoring (corresponding to simplified Evaluation).

As stated specifically in claim 1, this patent relies on previously defined models and schemas that undergo several steps that are scheduled:

“What is claimed is:
1. A method of automated data mining using a domain-specific analytic application for solving predefined problems, the method comprising:
   populating input data schema, the input data schema having a format appropriate to solution of a predefined problem;
   production training a predefined data mining model to produce a trained data mining model, the predefined data mining model comprising a predefined data mining model definition;
   production scoring input data from the input data schema; and
   scheduling the steps of populating input data schema, production training, and production scoring.”

The method presented allows a ready-made approach to data mining in very specific domains, for which most of the work has been previously done in the form of pre-defined data schemas and models, meant to work together to solve very specific problems. The scheduler describes a quite normal context function for the orderly execution of a single data mining process.

In the rest of the claims, further detail is provided on the layout of the predefined schemas and models, and the data exchanges between steps in the process.

The system described in IBM's patent simplifies the deployment of a data mining system. But, it is not intended to work as an exploratory tool to obtain knowledge about the optimal data mining schemas, models and execution steps. According to the claims, the context knowledge is provided manually in form of pre-defined schemas, models and steps. It is not an adaptive, domain-independent system, and so it cannot simplify the data mining expert's work, which is still fully needed during configuration of every step.

The whole Data Mining process as understood nowadays is a complex process that involves necessarily the manual intervention of experts and analysts in order to make sense of the results of the process.

The process itself is better understood as a pure roadmap with milestones indicating where the expert's assistance is needed. The overall description indicates that each of the boxes can only lead to the next if the results can be cross checked against the original purpose. The reasons for this are manifold:

The inductive process of extracting conclusions out of large amounts of collected data is a very lasting process. That constraint implies that trial and error, or even more exploratory techniques that might lead to the evaluation of different alternatives, are considered too costly and avoided. A typical solution is pre-configuration to limit the choices to a reduced number of pre-defined combinations.

The choice of useful data and its coding into more proper representations is a very manual step, where a lot of past experience and domain expert's knowledge take place. Therefore, the simple selection of data during the data understanding and preparation conditions the whole process to a manual decision. Again, the possibility to have an exploratory system to support in this step would allow data selection and combinations otherwise unbeknownst to the expert, to be found.

There exist wide combinations of complex fields (different techniques like advanced statistics, clustering or classification that belong to different complex disciplines) in place during the modeling phase that lead to the creation of specialized models for each different domain, which are difficult to abstract or isolate for its automation. These specialized models contain a large number of parameters and contextual information that is linked to the whole process, which means that is very difficult to, either, combine the disciplines into a single one knowing everything, or hardcode the different possibilities, as they all depend on the previous and next steps in the process.

Finally, the interpretation of results depends heavily on expert's skills to assess the goodness of results, usually through graphical representations or complex numerical dependencies.

All in all, the data mining process chain becomes a progression of experts-guided steps, with a lot of knowledge based decisions, made either manually or using predefined templates that capture the expert's decisions. This limitation makes existing solutions unable to truly automate the process.

A clear example is prior art patent US 20060112110, incorporated by reference herein, where automation is achieved by heavy pre-configuration manually by a data mining expert that simplifies deployment, but limits the system to a reduced number of pre-defined combinations.

### SUMMARY

The present invention pertains to a data mining system. The system comprises a planning and learning module which receives as input a knowledge model and a set of goals and automatically produces as output a number of plans. The system comprises a data mining processing unit which receives the plans as instructions and automatically creates results which are provided back to the planning and learning module as feedback.

The present invention pertains to a data mining system as. The system comprises means for planning and learning which receives as input a knowledge model and a set of goals and automatically produces as output a number of plans. The system comprises means for data mining and processing which receives the plans as instructions and automatically produces results which are provided back to the planning and learning module as feedback.

The present invention pertains to a method for data mining. A method comprises the steps of receiving as input at a planning and learning module a knowledge model and a set of goals. There is the step of automatically producing as output of the planning and learning module a number of plans from the input. There is the step of receiving by a data mining processing unit the plans as instructions. There is the step of automatically producing results by the data mining processing unit. There is the step of providing back to the planning and learning module the results as feedback.

### BRIEF DESCRIPTION OF THE DRAWINGS

In the accompanying drawings, the preferred embodiment of the invention and preferred methods of practicing the invention are illustrated in which:

FIG. 1 is a block diagram of the CRISP-DM industry standard data mining process.

FIG. 2 is a block diagram of the present invention.

FIG. 3 is a block diagram of the present invention.

FIG. 4 is a block diagram of the data preparation phase on a typical data mining process.

FIG. 5 is a block diagram regarding modifications needed for data collection feedback control.

FIG. 6 is a block diagram of an example of data collecting and mining from a network node.

FIG. 7 is a block diagram regarding example modifications for data collection feedback control.

FIG. 8 is a diagram of a blocks world sample problem for a typical automatic planner.

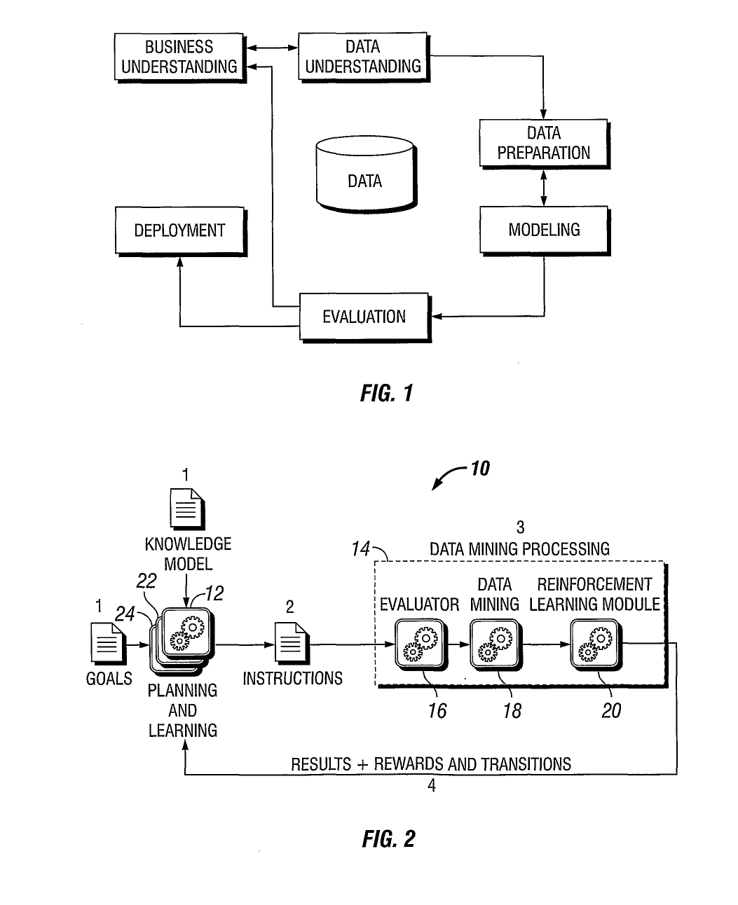

### DETAILED DESCRIPTION

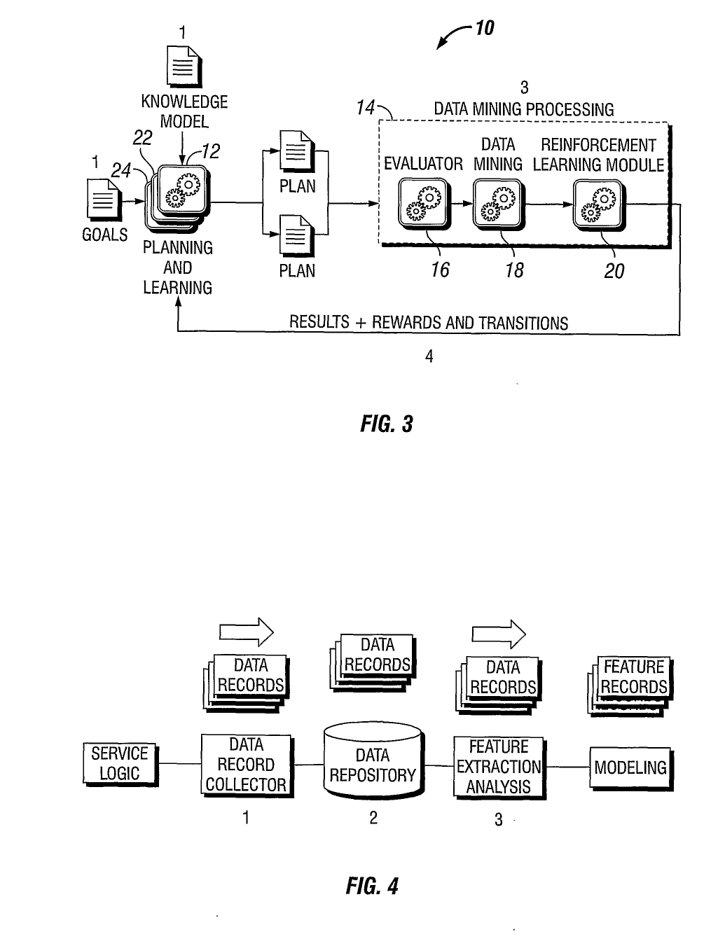

Referring now to the drawings wherein like reference numerals refer to similar or identical parts throughout the several views, and more specifically to FIGS. 2 and 3 thereof, there is shown a data mining system 10. The system comprises a:planning and learning module 12 which receives as input a knowledge model, which preferably includes a number of data and a set of goals and automatically produces as output a number of plans. The system comprises a data mining processing unit 14 which receives the plans as instructions and automatically produces results which are provided back to the planning and learning module 12 as feedback.

Preferably, the data mining processing unit includes an evaluator module 16 that chooses which plan of the number of plans to execute. The data mining processing unit preferably includes a data mining module 18 which mines the data based on the plan chosen by the evaluator module 16 and produces an outcome. Preferably, the data mining processing unit 14 includes a reinforcement learning module 20 which receives the outcome from the data mining module 18 and produces and sends reinforcement learning signals as feedback to the planning and learning module 12 so that the learning signals are used to correct or reinforce either the model used by the planning and learning module 12, or the plans produced therein, or both.

The data mining module 18 preferably performs data collection, preparation, analysis and evaluation of the data. Preferably, the planning and learning module 12 includes an automated planning part 22 which receives the goals and the model. The planning and learning module 12 preferably includes an automated learning part 24 which receives the feedback to correct or reinforce either the model used, or the plans, or both. Preferably, the outcome from the data mining module 18 is ranked and scored according to the plan by the reinforcement learning module 20 and included in the learning signals that are sent as feedback to the learning part 24. The planning and learning module 12 can have a first input unit which receives the knowledge model (of the environment), that includes a number of datasets, and the set of goals. The planning and learning module 12 can include a number of planners that produces the number of plans as alternative sets of instructions that, by operating on the model, achieve the goals. The planning and learning module 12 can include a first output unit for submitting the alternative sets of instructions and the datasets towards the data mining processing unit 14. In one embodiment the data mining processing unit 14 applies the alternative sets of instructions on the datasets. The evaluator module 16 can evaluates the alternatives to determine the most appropriate alternative to produce a result. The data mining processing unit 14 can include a second output unit for offering the number of results. The reinforcement learning module 20 can be coupled with the second output unit to feedback the planning and learning module 12 with the number of results, along with transitions and rewards scoring each result and usable for reinforcement learning purposes. The planning and learning module 20 can include a second input unit for receiving from the data mining processing unit 14 the results obtained, along with transitions and rewards scoring each result. The planners can be arranged for re-computing the sets of instructions, or the existing model, or both. The first output unit can be arranged for submitting the recomputed sets of instructions and the datasets towards the data mining processing unit 14.

The present invention pertains to a data mining system 10 as shown in FIGS. 2 and 3. The system comprises means for planning and learning which receives as input a knowledge model and a set of goals and automatically produces as output a number of plans. The system comprises means for data mining and processing which receives the plans as instructions and automatically produces results which are provided back to the planning and learning module 12 as feedback.

The planning and learning means can be the planning and learning module 12. The data mining and processing means can be the data mining processing unit 14.

The present invention pertains to a method for data mining. A method comprises the steps of receiving as input at a planning and learning module 12 a knowledge model and a set of goals. There is the step of automatically producing as output of the planning and learning module 12 a number of plans from the input. There is the step of receiving by a data mining processing unit 14 the number of plans as instructions. There is the step of automatically producing results by the data mining processing unit 14. There is the step of providing back to the planning and learning module 12 the results as feedback.

Preferably, there is the step of choosing with an evaluator module 16 of the data mining processing unit which plan of the number of plans to execute. There is preferably the step of mining the data with a data mining module 18 of the data mining processing unit based on the plan chosen by the evaluator module 16. Preferably, there is the step of producing an outcome by the data mining module 18. There is preferably the step of receiving by a reinforcement learning module 20 of the data mining processing unit the outcome from the data mining module 18. Preferably, there is the step of producing with the reinforcement learning module 20 reinforcement learning signals from the outcome. There is preferably the step of sending the reinforcement learning signals as feedback to the planning and learning module 12.

Preferably, there is the step of using the learning signals by the planning and learning module 12 to correct or reinforce either the model used by the planning and learning module 12, or the plans produced therein, or both. There is preferably the step of performing with the data mining module 18 data collection, preparation, analysis and evaluation of the data. Preferably, there is the step of receiving at an automated planning part 22 of the planning and learning module 12 the goals and the model. There is preferably the step of receiving at an automated learning part 24 of the planning and learning module 12 the feedback to correct or reinforce either the model used, or the plans, or both. Preferably, there is the step of ranking and scoring by the reinforcement learning module 20 the outcome from the data mining module 18 according to the plan and including the ranked and scored outcome in the learning signals that is sent as feedback to the learning part 24.

In the operation of the invention, one of the basic concepts of the invention is to define a mechanism that allows the Data Mining process to behave more autonomously. That mechanism relies on capturing and modeling the knowledge involved along the whole process of data mining, from data selection to evaluation of models outcome.

The model containing the knowledge involved on most of the situations and contexts that might be present in the process, together with the certainty about the proposed move forward, is the input to a subsystem (planner) that is able to propose the sequence of actions and configurations of each component used to achieve a certain goal.

Therefore, the invention comprises the combination of learning planning systems that configure and control a generic data mining process, based on the knowledge that experts are able to model out of the previous experience with the same or similar environments.

The combination of basic elements proposed by this invention, which in one possible embodiment could be seen as the components inside a single entity, and in other embodiments could be seen as separate collaborating modules, can be summarized in FIG. 2.

One of the core features of the invention is the Planning and learning module 12 devised to operate a Data Mining process that initially is provided with expert input through a model of the environment it is running on.
1. The process starts with a model comprising the knowledge modeled from the experts that manually run the system, and a set of goals to be fulfilled. It is not subject of this patent to include the modeling task or the definition of the goals, these are considered as input documents.
2. These two input documents to the Planning and learning module 12 trigger the production of a number of alternative sets of instructions that achieve a proposed input goal, according to different metrics (minimum computation time, maximum accuracy, etc). To produce the aforementioned instructions, this Planning and learning module 12 relies on automatic planners (see Automated Planning and Scheduling at Wikipedia.org, which is concerned with:
   the realization of strategies or action sequences, typically for execution by intelligent agents, autonomous robots and unmanned vehicles. Unlike classical control and classification problems, the solutions are complex, unknown and have to be discovered and optimized in multidimensional space.
3. The different alternatives are encoded in a data mining modeling language (i.e.: PMML) that will instruct the different stages how to operate with the different datasets considered for the problem to be solved.
   Optionally, and before running the instruction(s) set(s) from previous step, it is possible to assess which one is the most convenient (in terms of the metrics assigned when defining the goals). This can be done testing it on the real system or simulating and calculating the impact of running it.
   Finally, the evaluation will suggest selecting one of the alternatives, as the most appropriate for the problem suggested, and that one will be adopted by the data mining process to produce a final output.
4. The outcome from the data mining process can produce, as a result of a final evaluation from the human analysts of the system, re-computation of the existing metrics in the models, changes in the knowledge model, or even dropping the selected instructions set. This flow back to the system reflects its adaptability, and counts on human intervention, though this feedback can be also claimed to be automated by means of reinforcement learning signals. (Reinforcement Learning setup uses the definitions of the transitions and rewards for a system that tries to achieve a well defined goal.)

The following illustrates how the invention is able to automate a traditionally manual data mining process. For the sake of simplicity, such a process has been grouped and summarized into 4 main block steps.

Referring to FIG. 3, the Planning and learning module 12, represented as a box, receives as input a knowledge model and a set of goals, all corresponding to those in FIG. 2. As output, it provides a number of “Plans” which would be the sets of instructions for the Data Mining processing unit. The Data Mining processing unit is now further described, including some internal modules to clarify functions, although none of those are claimed by the present invention. And, as indicated previously, the results from Data Mining processing, are interpreted now as “Results+Rewards and Transitions”, and sent as feedback signals to the automatic Planning and learning module 12. This signal is intended for learning purposes, and not for iteratively improving the plan selection process. The feedback and the overall process is not iterative in the sense that the process keeps running regarding a search. The process simply runs once and the learning part is improved automatically through the feedback signals, in order to produce better results, next time the system is used. Of course if desired, the mining can be repeated, with the learning part having been possibly updated or improved from the feedback of the last execution, possibly resulting in better mining for the repeated execution.

FIG. 3 illustrates the detailed description of the invention.

The “Planning and Learning” box, receiving the aforementioned Knowledge Model and Goals as input, and producing a set of possible “Plans” that once evaluated can produce a set of instructions to be executed by a data mining system 10 is described in detail below.

The Data Mining Processing unit has been extended to illustrate the presence of an “Evaluator” module, describing an evaluation function that will decide which plan to apply, execute and evaluate. The intermediate “Data Mining” module would represent the actual data mining system 10 implementing the CRISP-DM data mining process. (As identified above, the CRISP-DM data mining process itself is well known in the art.) Also, the final outcome of the data mining process is received by a Reinforcement learning module 20 that takes care of it, producing and sending reinforcement learning signals as feedback to the Planning and learning module 12, so that those signals can be used to correct or reinforce the models used.

The following illustrates how the Planning and learning module 12 is fed with the models and goals to produce the Plans that will be evaluated and executed. Please note that those models and goals contains concepts that closely resemble the data mining concepts being modeled, but are abstractions used by the Planning and learning module 12 for its internal purposes. Those abstractions are used, for instance, as part of its detail description in each Plan, as it will be shown later on.

But, only when a particular Plan is selected to be executed, the abstractions get translated into concrete instructions in order to prepare and process data sets and produce observable results. The Evaluator would carry this translation, while the Data mining module 18 would be in charge of executing the instructions, as part of the Data Mining Processing unit tasks.

There are a number of sources of information that can be interesting in order to build the abstract knowledge model and goals that will be the input to the Planning and learning module 12.

The result of this modeling phase would be received by the “Planner” part inside the Planning and learning module 12. In order to know how to actually build such a Planner, see below, for detailed information about how a planner works, and what would be a preferred embodiment for this invention.

During the modeling phase, which is a manual step previous to applying the mechanisms in this invention, different information sources will be used in order to gather all desired information.
First, get context information to know about the environment.
Second, get information for each of the data mining steps in the process, that is, data preparation, analysis and evaluation that can happen later inside the Data Mining processing unit. Modeling how the manual data mining process is achieved represents the first effort in the way to automate such a complex set of tasks. For the representation of this sequential execution of steps, one of the most successful standards in the field, PMML (see Data Mining Group. PMML—Predictive Model Markup Language), can be reused and extended. The results of a data mining process span over the data sources, to the models employed and possible evaluations of the results obtained by those models. A brief description is shown below on each section for data preparation, analysis and evaluation.
Third, get domain knowledge from the expert and use it, along with the previously mentioned sources of information, to build the knowledge model and goals. More information on how the domain knowledge is captured and modeled in PDDL is provided below.

Context information can be understood as all the environment information used as source data for the data mining process.

Environment information comprises the network data repositories (static or provisioned, and dynamic or event logs) to be used, the psychological and geographical information about the users of the network where data mining process will be run, and the previous conclusions that could have been reached through previous data mining processes. A more comprehensive list of sample contextual (environment) information is the following:
Psychological/Geographical
Provisioned Profiles
Dynamic Data sources (network events)
Charging Information
Previous Inferred Knowledge
Geo-Location Information
Behavioral and Proximity information collected in user equipment
etc. . . .

Along with the description of the different repositories used, the data dictionary associated with them is described, which allows a generic automatic data mining process to understand it.

In the domain language specification of the context information, it is specified as many attributes as it is considered interesting for the reasoning of the automated planning algorithm. As with the previous information, there is also described data types, processing requirements or any other information that will enrich the search and decision process of the planning methods. For example:

```
(:objects d1 d2 - data
  a1 a2 a3 a4 - attribute
  c1 c2 c3 - class
  r1 r2 - result)
```

The description above defines two datasets: d1 and d2. Attributes a1 to a4, are also defined (without specifying yet which class or type they belong to). Three different data-types, called classes are also defined: c1, c2 and c3. And finally, r1 and r2 summarize how will be produced the results. This example might apply to HLR, HSS, charging, traffic, messaging, location or any other terminal or network data sources.

Data preparation is the first step in the data mining process, inside the Data mining module 18 of the Data Mining processing unit that is conceptually described in the Knowledge Model.

The sequence of concrete functions to be applied to the different data sets, in order to transform them into the more appropriate formats for each mining model, is described here. A typical list of data transformations is:
Normalization: map values to numbers, the input can be continuous or discrete.
Discretization: map continuous values to discrete values.
Value mapping: map discrete values to discrete values.
Functions: derive a value by applying a function to one or more parameters
Aggregation: summarize or collect groups of values, e.g., compute average.

The invention proposes to include knowledge information about what data is interesting to prepare for every type of problem, and also how to do that. The list above is therefore included in the list of possible actions to be selected in the domain knowledge, embedding in the preconditions and effects on them. This will allow the planner to select them properly under different conditions.

```
(:action pre-process-attributes
  :parameters (?a - attribute-selector ?d - data ?r - representation)
  :precondition (and (data-representation ?d ?r)
    (algorithm-representation ?a ?r) (not (processed ?a ?d)))
  :effect (and (processed ?a ?d)))
(:action pre-process-instances
  :parameters (?a - instance-selector ?d - data ?r - representation)
  :precondition (and (data-representation ?d ?r)
    (algorithm-representation ?a ?r))
  :effect (and (processed ?a ?d)))
```

The example above includes two actions that allow the preparation of the data. Each of them includes different pre-conditions, so the selection of any of those will depend on the problem specification and the goals.

For an advantageous embodiment of the present invention applied to the “Data Preparation” part of the Data mining process, in which the overall benefits of feedback and learning are illustrated below.

Analysis is the second step in the data mining process, inside the Data mining module 18 of the Data Mining processing unit that is conceptually described in the Knowledge Model. The description of the data mining techniques used (or the composition of them) is described. Different sections within the Knowledge Model will describe what techniques have been used, and what is the result obtained from applying them to the data sources. The format of the results will depend upon the data mining techniques used, since the output from a neural network differs from the output of a decision tree.

Our PDDL example model will then try to collect all possible methods available in the data mining toolbox, together with the pre-conditions that trigger one or another choice, and the effects of selecting them. For example:

```
(:action generate-classifier
  :parameters (?c - classification ?d - data ?r - representation
    ?s - class ?t - result)
  :precondition (and (data-representation ?d ?r)
    (algorithm-representation ?c ?r) (class ?s ?d) (class-type ?s nominal))
  :effect (and (classifier ?c ?d ?t) (result ?t ?d)))
```

This predicate belonging to the domain knowledge (generate-classifier) clearly states that in order to select a “classifier” for the analysis phase, the data representation (type) of the input data and the algorithm is the same. Similar further preconditions can be read in this oversimplified example.

Together with this small piece of knowledge instructing the adoption of a “classifier”, also present is the different definitions that lead to the formal representation of all the possibilities that exist:

```
(:constants nominal continuous - class-type
  classifier predictor clusters association-rules - result
  wrapper - attribute-selector
  spread-sub-sample - instance-selector
  c45-tree c45-rules svm knn naive-bayes tilde ribl ibl - classification
  m5 neural-networks - prediction
  em k-means cobweb relational-k-means - clustering
  a-priori warmr - association
  cross-validation training-set-evaluation - evaluation
  propositional relational - representation)
```

Finally, Evaluation is the third and last step in the data mining process, inside the Data mining module 18 of the Data Mining processing unit that is conceptually described in the Knowledge Model. This manual Evaluation stage contains valid interpretations of the results, to the light of the problem to be solved. That is, if a classification problem is being solved, this section of the results will describe how to correctly interpret the results obtained from the model.

For instance, if the business question is “What users are more likely to adopt a new pricing offer?”, and a classifier technique was used, the Evaluation step will describe how the different groupings of users found as results of the classifier can be used to answer to the business question.

By using the different sources of information described herein and the experience from the field expert in data mining, the Knowledge Model and Goals can be built, using and extending known standards.

The representation of the sequential manual steps is proposed to be enriched with expert knowledge about “how” and “when” applying the different alternative configurations and methods that are feasible to apply. This process can be done using symbolic representations, like predicate logic, STRIPS or PDDL (Planning Domain Definition Language).

By using symbolic representations, it is proposed to have a way of mapping near-natural-language statements into first or second order logic programs that can be interpreted by the appropriate automatic planners, as requirements to be fulfilled.

See below for a description and example on how the domain knowledge can be represented in PDDL.

After the modeling phase has rendered its result in the shape of a Knowledge Model and a set of Goals, this would be received as input by the “Planner” part inside the Planning and learning module 12. How to actually build such a Planner, based on the automatic planner state of the art is now described.

The automatic planners can propose the sequence of actions that better fulfill the set of requirements proposed as input, by using the knowledge model described above. This problem of planning is a classical artificial intelligence problem that can be summarized as follows:

Planning consists on given a domain theory (set of states and operators) and a problem (initial state and set of goals), obtain a plan (set of operators and an partial order of execution among them) such that, when executed, transforms the initial state in a state where all goals are achieved.

The domain theory is the symbolic description of the possible actions that can be performed by a data mining system 10, and the set of circumstances that are to be fulfilled to do so. The initial state and goals form the input to the automatic data mining system 10. This is what is to be found, from which data sets and methods available. Finally, the planner will produce an order list of actions that when executed in order will produce the desired goal.

See below for a description and example on how a planner works.

A possible embodiment of the previous example, applied to the data mining process, can be summarized in the predicates list provided here, of a domain description. Recall that a very straightforward data mining process consists of the following steps:
Pre-process instances (cardinality reduction)
Pre-process attributes (dimensionality reduction)
Analyze datasets (to cluster, classify, etc. . . . )
Evaluate results

So, the corresponding symbolic representation of the above actions can be:

```
(define (domain example)
(:action pre-process-instances
  :parameters (?a - instance-selector ?d - data ?r - representation)
  :precondition (and (data-representation ?d ?r)
    (algorithm-representation ?a ?r))
  :effect (and (processed ?a ?d)))
(:action pre-process-attributes
  :parameters (?a - attribute-selector ?d - data ?r - representation)
  :precondition (and (data-representation ?d ?r)
    (algorithm-representation ?a ?r) (not (processed ?a ?d)))
  :effect (and (processed ?a ?d)))
(:action generate-classifier
  :parameters (?c - classification ?d - data ?r - representation
  ?s - class ?t - result)
  :precondition (and (data-representation ?d ?r)
    (algorithm-representation ?c ?r) (class ?s ?d) (class-type ?s nominal))
  :effect (and (classifier ?c ?d ?t) (result ?t ?d)))
(:action evaluate-result
  :parameters (?t - result ?e - evaluation ?d - data)
  :precondition (and (result ?t ?d))
  :effect (and (evaluated ?d))
)
```

Combining those actions described above, with the description of the problem domain and the goal expected, a data mining process chain will be produced. The problem domain will look like this (together with the problem goal, and the metrics to be used):

```
(define (problem p1)
  (:domain example)
  (:objects d1 d2 - data
    a1 a2 a3 a4 - attribute
    c1 c2 c3 - class
    r1 r2 - result)
  (:init
    (= (number-instances d1) 300)
    (= (number-instances d2) 2000)
    (attribute a1 d1)
    (attribute a2 d1)
    (attribute a3 d1)
    (attribute a2 d2)
    (attribute a4 d2)
    (=(number-attributes d1) 3)
    (=(number-attributes d2) 2)
    (class c1 d1)
    (class c2 d1)
    (class c3 d2)
    (class-type c1 nominal)
    (class-type c2 nominal)
    (class-type c3 continuous)
    (data-representation d1 propositional)
    (data-representation d2 propositional)
    (= (expected-accuracy r1) 0.9)
    (= (expected-accuracy r2) 0.8) )
    (:goal (and (evaluated d1) (evaluated d2) ) )
    (:metric minimize (exec-time))
)
```

And, eventually, the outcome of the planner will look like the following set of instructions and parameters that instruct the underlying data mining system 10 to run the whole sequence of steps.
1: PRE-PROCESS-INSTANCES (MAP-REDUCE D1 PROPOSITIONAL)
2: PRE-PROCESS-ATTRIBUTES (PCA D1 PROPOSITIONAL)
3: GENERATE-CLASSIFIER (IBL D1 PROPOSITIONAL C1 CLASSIFIER
PCA MAP-REDUCE)
4: EVALUATE-RESULT (CLASSIFIER TRAINING-SET-EVALUATION D1)

The previous example only shows a very simple plan that is executed in the correct order to produce the expected results. The list of possible actions can be further expanded to offer different alternatives of achieving the same goal. And there can be also domain descriptions that are able to fulfill different goals and different possibilities for all of them.

The result of the Planning and learning module 12 would then be one or more Plans that would be received by the Evaluator module 16 inside the Data Mining processing unit.

Once the sequence and configuration has been proposed, one scheduler is responsible for executing the actions in the proposed order, with the selected parameters. The format can be exactly the same as the one proposed in step 1, for describing the process. This sequence can also be a list of equally possible sequences that is evaluated to check which better fits. The scheduler is also responsible to evaluate the result and provide that feedback in terms of changes to the knowledge model.

Generally, before the scheduling process starts, that whenever more than one plan is produced, they will be evaluated to decide which one is more suitable according to the goals and setup of the data mining process.

Inside the Data Mining processing unit, the Data mining module 18 receives the input instructions from the Evaluator, in order to actually perform each of the data mining steps in the process, that is, data preparation, analysis and evaluation, as for instance, in the CRISP-DM process description.

As the whole process was previously modeled, the Data mining module 18 could get the instructions, in a possible embodiment as a PMML document, and process them in order to execute complex sets of data mining tasks.

The Reinforcement learning module 20 inside the Data Mining processing unit would receive the outcome from the Data mining module 18.

As seen previously, the Planning and learning module 12 could provide different possible Plans, and so, the results from the Data mining module 18 according to each Plan that was executed is processed for ranking and scoring, but this module also creates reinforcement learning signals, and sends those signals as feedback to the Planning and learning module 12, so that they can be used to correct or reinforce the models used.

So, the overall Results from the Data Mining processing unit are not exclusively the data mining results, but also the set of signals related to the Learning part 24 within the Planning and learning module 12, that provides both Rewards for each Plan according to the accuracy of results, and Transitions used to reach the Goals.

Inside the Planning and learning module 12, there is a “Leaning” part that receives the reinforcement learning signals from the Reinforcement learning module 20 inside the Data Mining processing unit. How this Learning part 24 works is now described.

The Learning part 24 basically interprets the feedback mechanisms provided by a data mining system 10 in order to evaluate and compare how good (according to different metrics) the different alternatives are, and therefore, selecting the most appropriate.

The feedback signals provided are interpreted in the following way:
Results from the data mining techniques are associated to the Plan that was initially sent to the Data Mining processing unit.
Rewards to rank Plans by the higher accuracy of results, measured according to the metric used by the Planner. One possible alternative would be to use a planner based on Metric-FF (see Metric-FF Domain-independent Planning System), and so the signals would be formatted to the needs of that type of planner.
Transitions, indicating the state transitions used to fulfill the Plan and reach the Goals. This is also dependant on the type of planner and its internal arrangement and data structures, such as the presence or not of a state-transition table.

By processing the incoming reinforcement learning signals, the Learning part 24 of the Planning and learning module 12 is able to build and incorporate new control knowledge.

By leveraging on the control knowledge built by the Learning part 24, the Planner part can, as a possible consequence, prioritize the selection of the most accurate Plans according to previous results, rewards and transitions, in order to get better chances of obtaining accurate results in successive executions of the data mining process.

Therefore, the invention consists of the combination of learning-enabled planning systems that configure and control a generic data mining process, based on the knowledge that experts are able to model out of the previous experience with the same or similar environments.

In the Data Preparation phase, a first step is the collecting of data from sources, which usually results in large amounts of data stored in a data repository such as the “Data” component in FIG. 3.

Next step in Preparation is to apply so-called feature extraction techniques in order to reduce the number of features (attributes, fields) included in the data, by eliminating or “extracting” the non-relevant. A typical such technique is Principal Component Analysis (PCA) that is described in prior art patent US 20060112110, incorporated by reference herein. Briefly, PCA applies statistical techniques to the dataset, to rank higher those fields that have values with more variance (that represent the data set better), and rank lower those fields with constant values or very little variance.

By applying Feature Extraction, a new version of the data is obtained, where a good amount of the original data has been discarded without losing the most relevant data used to obtain the desired results, but anyway bringing down the amount of data that is to be mined. For instance, in a set of Call Data Record (CDR) data from a Charging system in a telecoms network, the most relevant attributes or fields might be those such as: IMSI, From, To, CallStartTime, CallEndTime, etc.

In FIG. 4, the data collecting and the feature extraction steps are shown in an example of a typical data mining deployment.
1) A Data Record Collector element that collects Data Records from the source, depicted in this example as a Service Logic element in a network.
2) A Data Repository element serves as storage for the collected data.
3) A Feature Extraction Analysis element accesses the Data Repository in order to process the data and identify the most prominent attributes or features. The transformed and reduced Feature Records are then passed to the Modeling element for further processing.

The collection of Data Records is usually an ad-hoc part of the process, highly dependent on the details of the data source, or Service Logic element presented in the example FIG. 4. This would then impose that the data is interchanged as text files over FTP as is sometimes the case with network log data, or maybe as database queries and responses in case the source is an RDBMS-capable element.

Regarding the layout of the data, it is almost impossible to know “at first sight” by looking at the data, which of the attributes (or features, or fields) will be relevant and which won't, for the purpose of data mining. So, the process as described (1, 2 and 3 from FIG. 2) will be a necessary part of the present invention, up until the moment in which the really relevant features on the data are identified.

At that very point, the present invention proposes the introduction on a number of modifications on the existing elements, so that a feedback loop is enabled between the Feature Extraction Analysis element, and the Data Record Collector elements.

Also, another modification can occur so that the process can work with existing data records in its original format, but also recognizes the new feature records that correspond to a reduced format with only relevant features or attributes. The new records do not have to undergo Feature Extraction again, so they are handled differently.

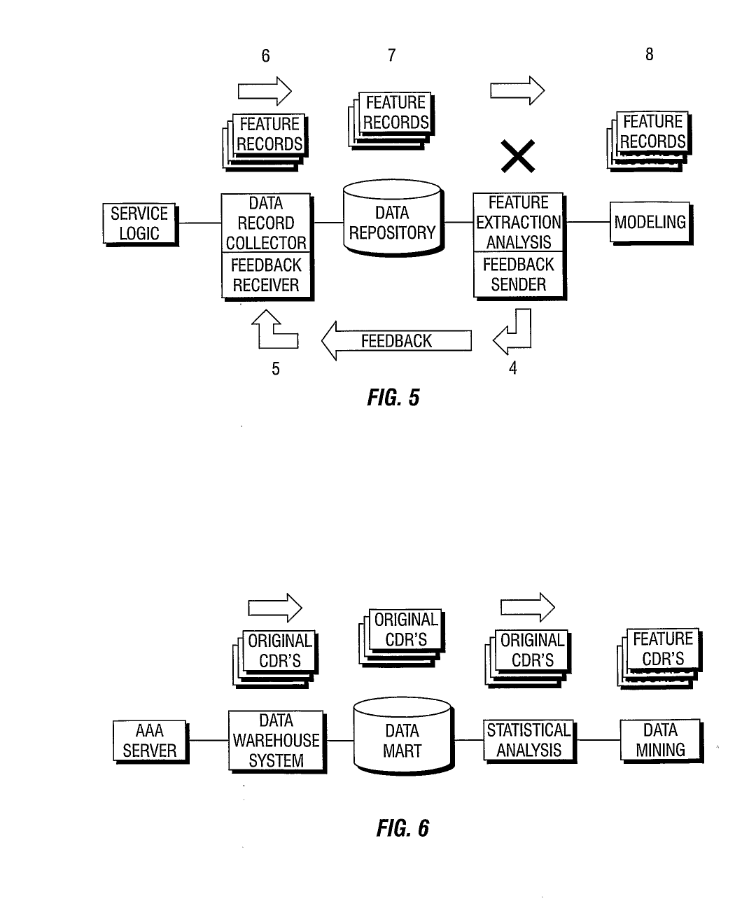

This is shown in FIG. 5.
4) The Feature Extraction Analysis element has a new Feedback Sender component that allows it to feed back to the Data Record Collector element with information on the most relevant attributes or features that have been identified for the Data Record just processed.
5) The Data Record Collector element has a new Feedback Receiver that collects Data Records from the source, depicted in this example as a Service Logic element in a network.
6) The Feature Records are fetched from the data source according to the new layout that discards non-relevant attributes or features, and also are marked as being Feature Records, in order to be distinguished from plain Data Records during further processing.
7) The Data Repository element stores the collected data, including the mark or flag that identifies Feature Record data. Apart from being able to store the new data, no modifications are foreseen for the Data Repository itself.
8) The Feature Extraction Analysis step is skipped for Feature Records, as they already contain just the most relevant attributes or features, and are then passed straight away to the Modeling element.

An implementation of the mechanisms presented in this invention is now described, which should be seen as a first example of the many possible.

For instance, in a telecom network, there can be the following setup:
Service Logic: a network node such as an Authentication Authorization and Accounting (AAA) Server, producing CDRs.
Data Records: a set of Call Data Records (CDRs) describing data-service sessions, including fields or attributes such as: Source IP address, Service type, URL accessed, start time, end time, duration of access, session-id, comments, sequence-id and CRC-code.
Data Collector: a Data Warehouse System (DWS) collecting CDRs.
Data Repository: CDRs are stored in a so-called Data Mart database.
Feature Extraction: a Statistical Analysis application to apply a statistical analysis (PCA for instance) to incoming CDR data and find the most relevant attributes.
Modeling: a Data Mining application that can produce a service-usage profiling model out of the most relevant attributes in the CDR.

This setup is shown in FIG. 6.

For the purpose of Data Mining in a telecoms networks scenario, let's now suppose that the most relevant attributes or fields found using the statistical analysis (PCA in this case) are these: Source IP address, Service type, URL accessed, start time, end time. These would be included in a Feature CDR.

In order to optimize the data collected to only the most relevant, the mechanisms in the present invention are used to instruct the data collecting step to discard the non-relevant attributes: duration of access, session-id, comments, sequence-id and CRC-code.

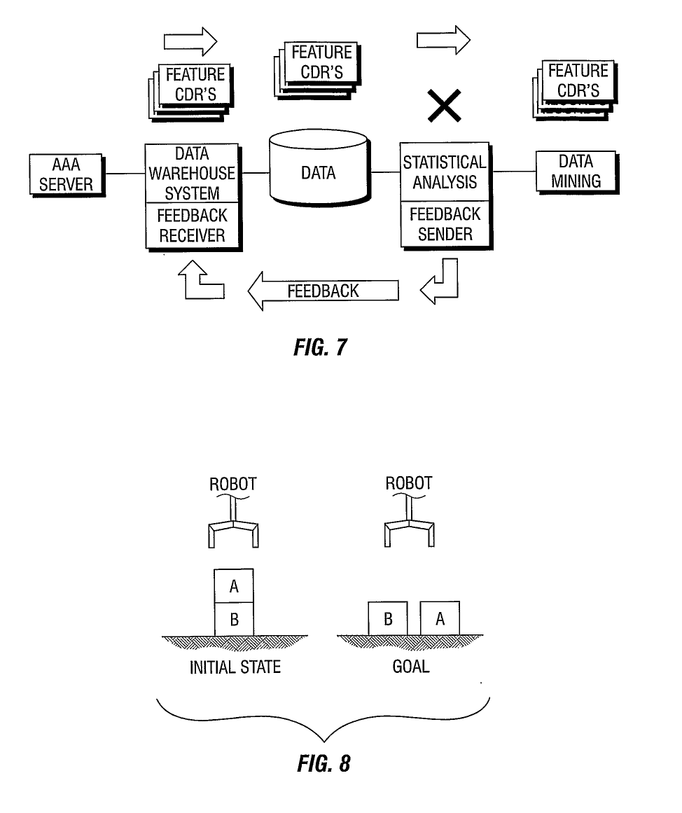

FIG. 7 shows the example setup with the modifications.

The steps used are the same described previously in FIG. 3, which are now applied to this concrete example.

A new type of CDR is to be collected from the AAA Server, so that only the most relevant attributes are included. That kind of CDR will be the Feature CDR. It will also include a new attribute to help identify it. In a possible implementation, that attribute could be named “FeatureCDR” and would always have a value of “1”, when present.

The Data Warehouse System will collect the Feature CDRs and store them in the Data Mart. The Statistical Analysis step will identify the Feature CDRs thanks to the attribute “FeatureCDR” being present, and skip execution, sending the Feature CDRs directly to the Data Mining element.

The same effects would be produced if several of the elements mentioned in the previous example were changed:
Service Logic: This setup could be applied to any other nodes in a telecom network such as HLR, HSS, CSCF, etc. or even to non-telecom servers from which relevant data can be collected.
Data Records Instead of Call Data Records (CDRs), data could be found as lines in text files of event logs from service or network nodes, or as rows in SQL tables in a database, or be the output of business support systems (charging or others) in an XML notation, or even be the results of other Data Mining systems.
Data Collector: instead of a Data Warehouse System (DWS) the data collector could be any Extract, Transform and Load (ETL) industrial application to process and store data, or an ad-hoc program (Java,) or even script-based filtering like Python, Perl, Awk, Sed, etc.
Data Repository: any kind of database could fulfill this functionality, even plain files indexed by their name and stored in a file system.
Feature Extraction Any type of analysis that allows identifying some attributes that are considered more relevant than others is applicable here. That includes statistical methods (PCA, histograms, means, standard deviation, etc.), or others, for instance observing the data distribution by visualization techniques and discarding those attributes with mostly null values.
Modeling: the Modeling element can be any application that works with input data that is optimized so that non-relevant data has been previously removed.

As a result of discarding non-relevant data very early in the process, there will be an overall effect in that a smaller amount data will have to be transmitted and stored, and collection will be faster, require less bandwidth and also take less storage resources in databases.

In the cases where the Feature Extraction step is not repeated due to the fact that the collected data does not contain non-relevant attributes or features, there will be less processing to do in order to produce the Feature Records at a later stage, and the impression will be of a faster data mining process.

And, when data collection feedback is applied to several nodes, the mentioned benefits would sum up overall, with greatly reduced data sets traversing the networks and using much less storage.

As an example, a symbolic representation of the experts' knowledge might enable the translation of sentences like the following:

```
Natural language:
“it should always happen that if an object is inside an airplane in a given state
  and the airplane is not in the destination city of the object, then in the
  next state the object should stay in the airplane”
Into, formally:
  (forall [p : airplane(p)] exists [l :at(p, l)]
  forall [o : in-wrong-city(o, l)] in(o, p) ) => o in(o, p))
Or programmatically:
(always (forall (?p) (airplane ?p)
  (exists (?l) (at ?p ?l)
  (forall (?o) (in-wrong-city ?o ?l)
    (implies (in ?o ?p)
      (next (in ?o ?p)))))))
```

This approach allows reflecting expert decision in a computer tractable manner, though the example is not related at all with the data mining field.

In FIG. 8, it has been depicted a typical pedagogical example of what a simple planner is expected to deliver.

The knowledge model contains the following information: there is a robot arm which is capable of four operations:

to pickup a block,

to putdown a block,

to stack a block on top of another block and

unstuck a block.

There some other predicates (in symbolic representation) that are able to represent the state of the different blocks and the robot arm itself:

holding (is the robot holding a block?),

ontable (is a block, on top of the table?) and

clear (has a block any other block on top of itself?).

By using these 3 predicates and the four operations (actions) described, an automatic planner which is fed with the initial state and goal, will produce the following output:

UNSTACK (A, B),

PUTDOWN (A)

This is a rather simplistic example, but shows what the final purpose of using planners is: they provide an automatic way of searching and finding sequences of actions that fulfill a goal, from an initial state.

The automation of the traditionally manual data mining process:
Lowers the level of complexity threshold of the traditional data mining operation systems, by largely reducing the number of tweaks, dependencies, configuration points, resulting in a lower OPEX.
Allow the automatic exploration of different mining possibilities that fulfill the same goal.
The system is able to learn successful automatic sequences of actions, storing them in cases repositories, that allow re-use and open interpretation.

### ABBREVIATIONS

OPEX—Operation Expenses.

ML—Machine Learning

PDDL—Planning Domain Definition Language

PPDDL—Probabilistic Planning Domain Definition Language

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A data mining system comprising:
a planning and learning module having a first input unit, which receives as input a knowledge model with a number of data and a set of goals, a number of planners for producing the number of plans, and a first output unit for automatically submitting the number of plans and the number of data towards a data mining processing unit; and
the data mining processing unit having an evaluator module, which chooses a plan of the number of plans to execute, a data mining module which mines the number of data based on the plan chosen by the evaluator module and automatically produces an outcome, and a reinforcement learning module which receives the outcome from the data mining module and produces and sends reinforcement learning signals to the planning and learning module as feedback, wherein the reinforcement learning signals are used to correct or reinforce either the model used by the planning and learning module, or the plans produced therein, or both.

2. A system as described in claim 1 wherein the planning and learning module includes an automated learning part which receives the feedback to correct or reinforce either the model used, or the plans, or both.

3. A system as described in claim 2 wherein the outcome from the data mining module is ranked and scored according to the plan by the reinforcement learning module and included in the reinforcement learning signals that are sent as feedback to the learning part.

4. A system as described in claim 1 wherein the planners produce the number of plans as alternative sets of instructions that, by operating on the model, achieve the goals.

5. A system as described in claim 4 wherein the data mining processing unit applies the alternative sets of instructions on the number of data.

6. A system as described in claim 5 wherein the evaluator module evaluates the alternatives to determine the most appropriate alternative to produce a result.

7. A system as described in claim 6 wherein the data mining processing unit includes a second output unit for offering the number of results.

8. A system as described in claim 7 wherein the reinforcement learning module is coupled with the second output unit to feedback the planning and learning module with the number of results, along with transitions and rewards scoring each result and usable for reinforcement learning purposes.

9. A system as described in claim 8 wherein the planning and learning module includes a second input unit for receiving from the data mining processing unit the results obtained, along with transitions and rewards scoring each result.

10. A system as described in claim 9 wherein the planners are arranged for re-computing the sets of instructions, or the existing model, or both.

11. A system as described in claim 10 wherein the first output unit is arranged for submitting the recomputed sets of instructions and the number of data towards the data mining processing unit.

12. A method for data mining comprising the steps of:
receiving as input at a planning and learning module a knowledge model with a number of data and a set of goals;
automatically producing as output of the planning and learning module a number of plans from the input;
receiving by a data mining processing unit the number of plans and the number of data;
choosing with an evaluator module of the data mining processing unit which plan of the number of plans to execute;
mining the data with a data mining module of the data mining processing unit based on the plan chosen by the evaluator module to produce an outcome by the data mining module;
producing with a reinforcement learning module reinforcement learning signals from the outcome;
providing back to the planning and learning module the reinforcement learning signals as feedback; and
using the reinforcement learning signals by the planning and learning module to correct or reinforce either the model used by the planning and learning module, or the plans produced therein, or both.

13. A method as described in claim 12 including the step of receiving by a reinforcement learning module of the data mining processing unit the outcome from the data mining module.

14. A method as described in claim 12 including the step of receiving at an automated learning part of the planning and learning module the feedback to correct or reinforce either the model used, or the plans, or both.

15. A method as described in claim 14 including the step of ranking and scoring by the reinforcement learning module the outcome from the data mining module according to the plan and including the ranked and scored outcome in the learning signals that is sent as feedback to the learning part.
